(19) United States
(12) Patent Application Publication
(10) Pub. No.: US 2022/0095829 A1
(43) Pub. Date: Mar. 31, 2022

(54) Induction-Compatible Sol-Gel Coating

(71) Applicant: SEB S.A., Ecully (FR)

(72) Inventor: Aurelien Berrux, La Motte Servolex (FR)

(73) Assignee: SEB S.A., Ecully (FR)

(21) Appl. No.: 17/424,032

(22) PCT Filed: Jan. 17, 2020
(86) PCT No.: PCT/EP2020/051194

§ 371 Date: Jul. 19, 2021

(30) Foreign Application Priority Data
Jan. 21, 2019 (FR) FR1900511

(51) Int. Cl. A47J 36/02; C09D 5/24; B05D 3/02; C09D 5/23; C09D 7/61; C08K 3/08; C09D 183/14

(52) U.S. Cl. CPC A47J 36/025; B05D 2301/30; B05D 3/0254; C09D 5/23; C09D 7/61; C08K 3/08; C09D 183/14; B05D 2518/12; C08K 2003/0806; C08K 2201/001; C08K 2201/01; C08K 2201/006; C08K 2201/005; C08K 2003/0812; B05D 2203/30; C09D 5/24

(57) ABSTRACT

The present invention relates to a sol-gel coating composition comprising conductive fillers, intended to make a culinary article compatible with induction.

### TECHNICAL FIELD

The present invention relates to the field of induction-compatible culinary articles. For the purposes of the invention, “induction-compatible” means the ability to be compatible with the induction heating technique, in particular compatible with induction cooktops. It is understood that the expression “inductive” has the same meaning as the expression “induction-compatible”. An induction cooktop generally consists of an inductor powered by an alternating current. When a conductive material is placed over this inductor, a variable magnetic flux flows through it and becomes the seat of an electromotive force of induction. The so-called eddy currents induced in the conductive material cause it to heat by Joule effect. This effect is the thermal manifestation of the electrical resistance that occurs as the current passes through the conductive material. Thermal energy is transmitted to the food by thermal conduction and thus heats it. A representation of this principle is shown in FIG. 1.

### PRIOR ART

There are known culinary articles that are induction-compatible either because their support is inherently inductive or because their support has been treated to make it inductive or because a part of an inductive nature has been added to the support. Inherently inductive supports are, for example, ferritic metal supports (for example steel, stainless steel, or cast steel) that may or may not be coated with a coating, in particular a non-stick coating. Supports made inductive are, for example, aluminum, glass, ceramic or copper supports whose outer bottom comprises a ferromagnetic insert (for example a ferritic metal part joined to the support by coining or bonding) or whose outer bottom has been treated by a plasma deposit consisting of ferromagnetic elements as in patent FR 2882240.

When the support is inherently inductive, it is not necessary to make it inductive and therefore no additional treatment is necessary, but this type of support has the great disadvantage of being a poor conductor of heat and causing harmful hot spots when cooking food. Pyrolysis can sometimes appear at the hot spots and destroy the food.

When the support is not inherently inductive and has to be made inductive, this requires one or more additional treatment operations, and therefore increases the cost of manufacturing the culinary article. Moreover, non-inductive supports such as aluminum, glass, ceramic or copper are not easily enameled (poor adhesion of the coating, pitting of the coating) and are expensive. Patent application FR 2882240 describes a plasma deposit consisting of ferromagnetic elements on the outside of the culinary article, in order to make it induction-compatible. The deposition of powder on the article leads to surface roughness which must be smoothed out by sanding or by depositing a finishing lacquer, with the aim of making the outer surface less irregular, thus making the production process complex and expensive. Also, this process, carried out at very high temperatures (between 200 and 800° C.) and using powder, is restrictive, generating working condition and safety problems for production line workers. It is therefore also necessary to overcome these constraints in order to guarantee worker safety. Moreover, such articles are poorly resistant to hydrolysis phenomena, encountered during dishwasher cycles.

In addition to these issues, certain toxic compounds may be used in coatings intended to make a support inductive. In patent application CN 108610671, a magnetically-conductive coating is applied to the outside of a ceramic culinary article for an electromagnetic heating application and comprises an epoxy resin as binding agent. Bisphenol A is a compound in the epoxy resin, and during the resin curing process, it is often incompletely removed. Thus, some bisphenol A remains in the resin used as binding agent and is applied to the culinary article. There is therefore a risk of toxicity for the end user, in particular during thermal use cycles, with the release of decomposition by-products harmful to health and/or of bisphenol A, a recognized endocrine disruptor which poses public health problems.

### DISCLOSURE OF THE INVENTION

It has therefore become necessary to propose culinary articles whose support is not inherently inductive (for example glass, aluminum, ceramic, copper, pottery, porous terracotta, plastic supports), which are induction-compatible, whose manufacturing cost is reasonable, exhibiting excellent heat conduction, homogeneously, without generating hot spots, and which is easily enameled. It is also necessary that these culinary articles are produced under working conditions that guarantee worker safety with simplified processes and it is also essential to guarantee to users that these culinary articles are harmless.

The applicant has developed a sol-gel coating composition for making a culinary article induction-compatible.

The advantages of this sol-gel coating composition are the ability to make induction-compatible any type of support that accepts a sol-gel coating, while providing good thermal resistance up to 300° C., excellent resistance to hydrolysis, particularly when run through a dishwasher, and very good cleanability.

Thus, the present invention relates to a sol-gel coating composition comprising conductive fillers, intended to make a culinary article induction-compatible.

The invention also relates to a sol-gel coating comprising at least one layer of the sol-gel coating composition in accordance with the invention.

The present invention also relates to a culinary article comprising a support coated with the sol-gel coating in accordance with the invention.

The invention also relates to a process for manufacturing an induction-compatible culinary article using the sol-gel coating composition in accordance with the invention.

Finally, the present invention relates to the use of conductive fillers to prepare a sol-gel coating in order to make a culinary article induction-compatible.

The present invention offers at least one of the following advantages:
the conductive fillers can be incorporated in very large amounts into the sol-gel coating composition in accordance with the invention, up to 90% by mass of the total mass of the composition, without degrading the stability of the sol-gel formulation;
the sol-gel coatings in accordance with the invention have the ability to make induction-compatible any type of support that accepts to be coated with this sol-gel coating, such as plastic, glass, pottery, porous terracotta, ceramic, copper, aluminum;
the sol-gel coatings in accordance with the invention exhibit a good homogeneity of heat diffusion; in particular these coatings do not exhibit hot spots when cooking food;
the sol-gel coatings in accordance with the invention are thermostable up to at least 500° C.;
the culinary articles coated with the sol-gel coating in accordance with the invention have good results in the context of slow cooking (simmering, gratin);
the process for manufacturing such culinary articles does not require high temperatures; indeed, the heat treatment temperature for curing the sol-gel coatings in accordance with the invention is much lower (generally 210-300° C.) than that required for enamel coatings, which is generally about 800° C., and therefore allows the use of material such as aluminum as support;
another advantage of conductive fillers is that they can be incorporated at any stage of the production of the sol-gel coating, without the need for specific prior treatment such as grinding for example.

The present invention therefore relates to a sol-gel coating composition comprising conductive fillers for making a culinary article induction-compatible.

For the purposes of the invention, “conductive filler” or “conductive material” is understood to be a filler or material capable of conducting electrical currents, such as eddy currents.

Preferably, the conductive fillers of the sol-gel coating composition in accordance with the invention are ferromagnetic, diamagnetic or paramagnetic.

For the purposes of the invention, “ferromagnetic filler” means a filler or material that forms a permanent magnet or is attracted by magnets. By way of ferromagnetic filler, mention may be made of iron, nickel, cobalt and most alloys thereof.

For the purposes of the invention, “paramagnetic filler” means a filler or material (such as aluminum) that does not possess spontaneous magnetization but that, under the effect of an external magnetic field, acquires a magnetization directed in the same direction as this excitation field. A paramagnetic filler or material thus has a magnetic susceptibility of positive value (unlike diamagnetic materials), which is generally quite weak. This magnetization disappears when the excitation field is cut.

For the purposes of the invention, “diamagnetic filler” means a filler or material (such as silver or copper) that, under the effect of a magnetic field, acquires a very weak magnetization opposite to the excitation field, and thus generates a magnetic field opposite to the excitation field. When the field is no longer applied, the magnetization disappears.

Preferably, the sol-gel coating composition in accordance with the invention comprises conductive fillers selected from silver, copper, aluminum, iron, nickel, cobalt, stainless steel, carbon black and mixtures thereof. Preferentially, the sol-gel coating composition in accordance with the invention comprises conductive fillers selected from silver, copper and aluminum. Even more preferentially, the sol-gel coating composition in accordance with the invention comprises conductive fillers of silver. Advantageously, the sol-gel coating composition in accordance with the invention comprises from 40 to 90% conductive fillers, more preferably from 50 to 85%, even more preferentially from 55 to 80%, and advantageously from 55 to 75%. The percentages are expressed by mass with respect to the total mass of the sol-gel coating composition in accordance with the invention.

The conductive fillers can be in different forms, in particular in the form of powders, flakes, encapsulated or non-encapsulated particles or mixtures thereof. It should be noted that, depending on their shape and size, the conductive fillers can agglomerate or disperse in the sol-gel coating composition.

Preferably, the sol-gel coating composition in accordance with the invention comprises conductive fillers that are particles in the form of very fine powder, so that the particles are very close to each other and can touch each other after the coating is obtained. It is preferable that the contact between the fillers be as high as possible, to create current density and conduction from near to near in the coating.

Preferably, the conductive fillers have a BET specific surface area of at least 0.5 m²/g, more preferentially at least 0.7 m²/g, which provides good electrical conductivity.

Based on the Brunauer, Emmett and Teller model (BET method), the specific surface area or air mass for a powder or solid is measured in order to determine the total surface area per unit mass of the product accessible to atoms and molecules. The measurement technique is based on the amount of nitrogen adsorbed in relation to its pressure at the boiling temperature of liquid nitrogen and under normal atmospheric pressure. This measurement of the total real surface of the fillers takes into account the presence of reliefs, irregularities, surface or internal cavities, porosity. The higher the BET specific surface area of the fillers, the greater the contact between the fillers.

The BET measurement equipment used will be for example Micromeritics Gemini VII 2390 associated with its Micromeritics Flowprep 060 sample preparation device.

Preferably, the sol-gel coating composition in accordance with the invention comprises conductive fillers which have a specific particle size distribution, with a D10 of 0.1 μm to 10 μm, more preferentially 0.2 μm to 8 μm.

Preferably, the sol-gel coating composition in accordance with the invention comprises conductive fillers which have a specific particle size distribution, with a D50 of 1 μm to 15 μm, more preferentially 2 μm to 12 μm.

Preferably, the sol-gel coating composition in accordance with the invention comprises conductive fillers which have a specific particle size distribution, with a D90 of 2 μm to 20 μm, more preferentially 3 μm to 15 μm.

Preferably, the sol-gel coating composition in accordance with the invention comprises conductive fillers which have a specific particle size distribution, with a D100 of 10 μm to 50 μm, more preferentially 10 μm to 28 μm.

In the alternative where the conductive fillers are silver fillers, they will preferably have a D10 of 0.2 μm to 1.5 μm, a D50 of 2 μm to 5 μm, a D90 of 3 μm to 11 μm and a D100 of 18 μm.

The D10, also denoted Dv10, is the 10^{th} percentile of the particle size volume distribution, i.e., 10% of the volume represents particles that are less than or equal to the D10 and 90% of the particles that are greater than the D10. Dv10 is defined in a similar manner.

The D50, also denoted Dv50, is the 50^{th} percentile of the particle size volume distribution, i.e., 50% of the volume represents particles that are less than or equal to the D50 and 50% of the particles that are greater than the D50. Dv50 is defined in a similar manner.

The D90, also denoted Dv90, is the 90^{th} percentile of the particle size volume distribution, i.e., 90% of the volume represents particles that are less than or equal to the D90 and 10% of the particles that are greater than the D90. The Dv90 is defined in a similar manner.

The D100, also denoted Dv100 or Dmax, is the 100^{th} percentile of the particle size volume distribution, i.e., 100% of the volume represents particles that are less than or equal to the D100. Dv100 or Dmax is defined in a similar manner.

Preferably, the conductive fillers will be selected to have a high degree of purity, close to 99.9%, mass percentage. Indeed, impurities could disturb the conduction of the fillers. Advantageously, the percentage of impurities by mass should be less than 0.1%, preferably less than 0.01%, mass percentages.

The sol-gel coating composition in accordance with the invention comprises at least one sol-gel precursor selected from sol-gel precursors of the metal or metalloid alkoxylate type and sol-gel precursors of the metal or metalloid polyalkoxylate type.

Advantageously, the sol-gel precursor is selected from the compounds corresponding to the formula Chem 1 or to the formula Chem 2 or to the formula Chem 3, wherein:
R¹, R², R³ or R^{3′} denote a C₁-C₄ alkyl group,
R^{2′} denote a C₁-C₄ alkyl group, or phenyl,
n is an integer corresponding to the maximum valency of the elements M¹, M² or M³,
M¹, M² or M³ denote an element selected from Si, B, Zr, Ti, Al, V.

M¹(OR¹)ₙ [Chem 1]

M²(OR²)₍ₙ₋₁₎R^{2′} [Chem 2]

M³(OR³)₍ₙ₋₂₎R^{3′}₂ [Chem 3]

As sol-gel precursor of the metal or metalloid alkoxylate type or sol-gel precursor of the metal or metalloid polyalkoxylate type that can be used in the sol-gel coating composition in accordance with the invention, mention may be made, inter alia, of aluminates, titanates, zirconates, vanadates, borates, polyalkoxysilanes and mixtures thereof.

Preferably, the sol-gel precursor comprises a polyalkoxysilane.

The sol-gel precursor is advantageously selected from methyltrimethoxysilane (MTMS), tetraethoxysilane (TEOS), methyltriethoxysilane (MTES) and dimethyldimethoxysilane or mixtures thereof.

Preferably, the sol-gel precursor comprises tetraethoxysilane (TEOS) and/or methyltriethoxysilane (MTES).

Advantageously, the sol-gel precursor of metalloid alkoxylate or polyalkoxylate is a borate, for example trimethylborate. The borate can further serve as an adhesion precursor on a pottery or glass type substrate. The boron element is well suited to this type of substrate because it has a low coefficient of expansion.

Advantageously, the sol-gel coating composition in accordance with the invention may further comprise a colloidal oxide, preferably a metal or metalloid oxide. Preferably, the metal or metalloid oxide is selected from silica, alumina, cerium oxide, zinc oxide, vanadium oxide, zirconium oxide and mixtures thereof.

Advantageously, the sol-gel coating composition in accordance with the invention comprises at least one sol-gel precursor as described above and at least 2% by mass based on the total mass of the composition of at least one colloidal oxide as described above dispersed in said composition. The sol-gel coating composition in accordance with the invention is intended to make a culinary article induction-compatible. Thus, the sol-gel coating composition in accordance with the invention makes it possible to produce an induction-compatible sol-gel coating.

Advantageously, the sol-gel coating composition in accordance with the invention is obtained by hydrolysis of the sol-gel precursor by adding water and an acidic or basic catalyst, followed by a condensation reaction leading to a sol-gel coating composition.

Advantageously, the sol-gel coating composition in accordance with the invention is in the liquid or semi-liquid state.

The sol-gel coating composition in accordance with the invention may comprise an acid catalyst such as for example acetic acid, formic acid, citric acid, hydrochloric acid, tartaric acid or mixtures thereof.

The sol-gel coating composition in accordance with the invention may comprise a basic catalyst such as for example sodium hydroxide NaOH, potassium hydroxide KOH, ammonia NH₄ or mixtures thereof.

The sol-gel coating composition in accordance with the invention may further comprise at least one pigment filler.

As pigment fillers that can be used in the context of the present invention, particular mention may be made of coated or uncoated mica, titanium dioxide, mixed oxides (spinels), alumino-silicates, iron oxides, carbon black, perylene red, metallic flakes, pigments, thermochromic organic dyes or mixtures thereof.

The main effect of these pigment fillers is to provide color, and furthermore to improve heat diffusion, to improve the hardness (and durability) of the sol-gel coating obtained from the composition in accordance with the invention and to have lubricating properties.

The sol-gel coating composition in accordance with the invention may further comprise at least one inorganic filler. These are, for example, fillers selected from boron nitride, molybdenum sulfide, graphite and mixtures thereof.

The sol-gel coating composition in accordance with the invention may further comprise at least one organic filler. By way of examples of organic fillers, particular mention may be made of PTFE powder, silicone beads, silicone resin, linear or three-dimensional polysilsesquioxanes (in particular in liquid or powder form), polyethylene sulfide (PES) powder, polyetheretherketone (PEEK) powder, phenyl polysulfide (PPS) powder, perfluoropropylvinylether (PFA) powder, polyurethane powder resins, acrylic resins and mixtures thereof.

A first preferred sol-gel coating composition in accordance with the invention, and intended to be applied by screen-printing on a support, may advantageously comprise a mixture of methyltriethoxysilane (MTES) and tetraethoxysilane (TEOS) as sol-gel precursors, and optionally trimethylborate.

A second preferred sol-gel coating composition in accordance with the invention, and intended to be applied by screen-printing on a support, may advantageously comprise a mixture of methyltriethoxysilane (MTES) and tetraethoxysilane (TEOS) as sol-gel precursors, and optionally trimethylborate, and alumina (as filler).

The invention also relates to a sol-gel coating using the sol-gel coating composition in accordance with the invention described above.

This coating can be made from the use of the sol-gel coating composition in accordance with the invention.

The sol-gel coating of the article in accordance with the invention can also be made from the use of a sol-gel coating composition comprising conductive fillers, intended to make a culinary article induction-compatible.

All that has been said above regarding conductive fillers for the sol-gel coating composition in accordance with the invention applies equally to the coating.

The sol-gel coating in accordance with the invention may comprise at least one layer of the sol-gel coating composition as described above.

For the purposes of the present invention, “sol-gel coating” means a coating synthesized by the sol-gel route. The coating thus obtained may be either organo-mineral or all-mineral.

For the purposes of the present invention, “sol-gel route” means the principle of synthesis comprising the transformation of a liquid phase precursor-based solution into a solid by a set of chemical reactions (hydrolysis and condensation) at low temperature.

Advantageously, the liquid phase precursor-based solution comprises sol-gel precursors of the metal or metalloid alkoxylate type and/or sol-gel precursors of the metal or metalloid polyalkoxylate type. Preferably, this is the sol-gel coating composition in accordance with the invention. All that has been said above concerning the sol-gel precursors for the sol-gel coating composition in accordance with the invention applies equally to the coating.

The sol-gel coating in accordance with the invention can be an organo-mineral coating or an all-mineral coating.

For the purposes of the present invention, “organo-mineral coating” means a coating whose network is essentially inorganic, but which contains organic groups, in particular because of the precursors used and the curing temperature of the coating or because of the incorporation of organic fillers.

For the purposes of the present invention, “all-mineral coating” means a coating based on an entirely inorganic material, free of any organic group. Such a coating can be obtained by the sol-gel route with a curing temperature of at least 400° C., or from metal or metalloid alkoxylate type precursors and/or metal or metalloid polyalkoxylate type precursors with a curing temperature which can be lower than 400° C.

Advantageously, the sol-gel coating in accordance with the invention comprises a sol-gel material comprising a matrix formed from at least one metal or metalloid alkoxylate or at least one metal or metalloid polyalkoxylate and at least 2% by mass based on the total mass of the coating of at least one colloidal oxide, preferably a metal or metalloid oxide, dispersed in said matrix.

The sol-gel coating in accordance with the invention can be arranged on a support either in a single layer or in several layers superimposed on each other.

The sol-gel coating in accordance with the invention may be in the form of a continuous or discontinuous layer, in particular if it includes a decoration. Preferably also, the decoration is applied by screen- or pad-printing. In particular, the decoration can be applied in accordance with the process described in French patent FR2576253.

Preferably, the coating in accordance with the invention forms a single, continuous layer. It can be envisaged that the sol-gel coating in accordance with the invention forms a discontinuous layer.

The sol-gel coating in accordance with the present invention has a resistivity comprised between 5.0·10⁻⁷ and 7.5·10⁻⁵ Ω·m, preferentially comprised between 8.0·10⁻⁷ and 3.6·10⁻⁵ Ω·m. Advantageously, the sol-gel coating in accordance with the invention is in the solid state.

The present invention also relates to a culinary article comprising a support coated with the sol-gel coating in accordance with the invention.

The present invention also relates to a culinary article comprising a support coated with the sol-gel coating in accordance with the invention after application of the sol-gel coating composition in accordance with the invention. After heat treatment, the sol-gel coating in accordance with the invention adheres to the support of the culinary article to form an article having a support coated with a sol-gel coating.

Generally, a portion of the support of the culinary article is coated with the sol-gel coating in accordance with the invention, but it can be envisaged that the entire support of the culinary article is coated. Generally, only the portion which is intended to be in contact with the induction heating means, in particular induction cooktops, is coated.

The partially or fully coated support of the culinary article in accordance with the invention can be made of inorganic material, such as glass or ceramic, or of organic material such as plastic.

Generally, the support of the culinary article, coated in part or in full, in accordance with the invention is not made of electrically conductive material.

The glass suitable as a coating support for the culinary article in accordance with the invention can be tempered borosilicate or glass-ceramic, which have the advantage of good mechanical strength and good resistance to thermal shock. This type of support can be obtained from glassmakers who have mastered the formulations, molding and tempering. The molding operation and the application of the coating composition can be dissociated, which can be advantageous for the implementation of a discontinuous process. A chemical or mechanical surface treatment may be useful to obtain a reinforced bond between the sol-gel coating and the glass support.

Stoneware and ceramics may also be suitable as coating supports for the culinary article in accordance with the invention. So-called “all-fire” ceramics generally use specific products, the shaping of which requires a great deal of know-how. The advantage of these materials is that they can withstand high thermal shock. These materials are preferably molded by gravity casting or by conventional or isostatic pressure for better productivity. The molding techniques allow various shapes to be obtained, then the molded materials are dried and fired for example by stages to 1400° C. in 4 hours. These raw objects, also called shards (because they are not coated), have a certain interesting roughness linked to the molding process and which it is preferable to control for the application of the sol-gel coating in accordance with the invention. A first layer of sol-gel coating composition in accordance with the invention or not can be applied by spray to the outside of the article in order to provide a better aesthetic appearance and, especially, to create an effective adhesion primer for the resistive or ferromagnetic layer in accordance with the invention described above. This “primer” layer is not essential because direct screen-printing of the inductive sol-gel layer in accordance with the invention is also possible.

Plastic may also be suitable as a coating support for the culinary article in accordance with the invention. In this case, it will be a plastic suitable for contact with food. Silicone can be mentioned in this respect, but as it is relatively flexible, it will be envisaged to be reinforced. It is also possible to mention syndiotactic polystyrene—30% FV resistant to 250° C. which may offer a proper solution for a reheating system. The sol-gel coating composition in accordance with the invention may optionally be specifically adapted to this support. For culinary articles with plastic supports, they can be used as a “keep warm” back-up system.

Advantageously, the support of the culinary article in accordance with the invention has an inner face intended to receive food and an outer face intended to be disposed toward the induction heating means.

Advantageously, the coating in accordance with the invention is arranged on at least one of the two faces of the support of the culinary article, preferably on the outer face.

Advantageously, the outer face of the support of the culinary article is coated with the sol-gel coating in accordance with the invention.

For the purposes of the present invention, “culinary article” means an object that will be heated by an external heating system, such as frying pans, saucepans, high-sided frying pans, stewpots, cooking pots, braising pans, woks, baking pans, caquelons, and more generally any container that has handles and is capable of transmitting the heat energy provided by this external heating system to a material or foodstuff in contact with said container.

The culinary article coated with the sol-gel coating in accordance with the invention is induction-compatible, in particular with induction cooktops having a power range of 45 watts to 3.5 kilowatts.

The invention also relates to a process for manufacturing an induction-compatible culinary article in accordance with the invention comprising the following successive steps:
(i) provide a support;
(ii) apply to the support the sol-gel coating composition in accordance with the invention comprising conductive fillers;
(iii) apply a heat treatment at a temperature of 200 to 500° C.;
(iv) obtain an article whose support is coated with a sol-gel coating.

The implementation of this process makes it possible to obtain an article whose support is coated with a sol-gel coating in accordance with the invention.

The support used in steps (i) and (ii) is the one described above.

Advantageously, the process in accordance with the invention may further comprise, prior to step i), a step of surface treatment of the face of the support intended to be coated. This surface treatment may consist of a chemical treatment (in particular chemical pickling) or a mechanical treatment (sandblasting, brushing, grinding, shot blasting for example) or a physical treatment (in particular by plasma), in order to create a roughness which will be favorable to the adhesion of the layer of sol-gel coating. The surface treatment can also be preceded by a degreasing operation to clean the surface.

Advantageously, the support is optionally cleaned and heated before application of the composition according to step (ii). The heating temperature may be comprised between 40 and 80° C., this preheating prevents dripping during application.

According to an alternative, step (ii) of the process in accordance with the invention may take place according to the following substeps:
prepare an aqueous composition (A) comprising at least one colloidal oxide, preferably a metal or metalloid oxide, a solvent comprising at least one alcohol, and optionally at least one silicone oil;
prepare a solution (B), preferably acidic, comprising conductive fillers and at least one sol-gel precursor selected from sol-gel precursors of the metal or metalloid alkoxylate type and sol-gel precursors of the metal or metalloid polyalkoxylate type;
mix the solution (B) with the aqueous composition (A) to obtain a sol-gel coating composition;
apply the resulting sol-gel coating composition to the support.

The presence of a solvent comprising at least one alcohol in the aqueous composition (A) improves the compatibility of the aqueous composition (A) with the solution (B).

However, it is possible to work without solvent, but in this case the choice of polyalkoxylates is reduced to those with excellent compatibility with water. An excessive amount of solvent (more than 20% by mass) is possible, but it generates unnecessary volatile organic compounds, which is not favorable for the environment.

Preferably, an oxygenated alcoholic solvent or an ether alcohol is used as the solvent in the aqueous composition (A) of the invention.

The solution (B) used in step (ii) may further comprise an organic acid such as for example acetic acid, formic acid, citric acid, hydrochloric acid or tartaric acid or mixtures thereof.

Preferred acids in accordance with the invention are organic acids, and more particularly acetic acid or formic acid.

After the preparation of the aqueous composition (A) and that of the solution (B), these two compositions are mixed together to form a sol-gel coating composition (A+B). The respective amounts of each of the compositions (A) and (B) are preferably adjusted so that the amount of colloidal silica in the sol-gel coating composition is 2 to 30%, percentage by mass based on the mass of the total dry matter.

The sol-gel coating composition (A+B) in accordance with the invention can be applied to the support by spraying or by any other method of application, such as dipping, dabbing, brushing, rolling, inkjet, curtain coating, centrifugal coating or screen-printing. However, spraying, for example by means of a spray gun, has the advantage of forming a homogeneous and continuous layer, which, after curing, forms a continuous, sealed coating of even thickness.

The application to the support, in step (ii) of the process in accordance with the invention, may take place by screen-printing, rolling, inkjet, spraying or curtain printing.

Application to the support, in step (ii) of the process in accordance with the invention, may take place by pyrolysis spraying comprising spraying or nebulization in the form of droplets of solution of the sol-gel coating composition. The application to the support, in step (ii) of the process in accordance with the invention, may also take place by flat coating techniques, which allow, on the one hand, a significant savings in coating consumption from an industrial point of view, and, on the other hand, the elimination of the problem of spraying outside the article (over-spray).

Advantageously, step (iii) of the process in accordance with the invention may take place at a temperature of 200 to 400° C., in particular at a temperature of 210 to 300° C., more particularly at a temperature of 220 to 280° C., preferably at 250° C.

A drying step may be envisaged between steps (ii) and (iii). Any means of drying can be considered, oven drying, drying by ultraviolet or infrared radiation, plasma drying, open air drying or a combination of these means of heating.

This optional drying step can allow the solvents to evaporate and avoid the stresses associated with densifying/curing the coating.

According to another alternative, it can be envisaged that the process also comprises, between the step ii) of applying the sol-gel coating composition to the support and the step iii) of heat treatment, the following two successive steps:
ii-1) a step of pre-densification of the support thus coated in order to obtain a sol-gel coating layer having a pencil hardness comprised in the range 4B to 4H; then
ii-2) a step of stamping the coated support until the final shape of the culinary article is obtained, with an inner face capable of receiving food and an outer face intended to be arranged on the side of a heat source, the stamped face being able to be either the face provided with the sol-gel coating layer or the face opposite thereto.

For the purposes of the present invention, “pencil hardness” means the resistance of coatings or lacquers to surface scratches. This hardness therefore indirectly reflects the state of condensation of the sol-gel. This pre-densification step of the sol-gel coating layer can advantageously consist of a drying step at a temperature comprised between 20° C. and 150° C., and more particularly by forced drying at a temperature comprised between 80° C. and 150° C. in a conventional curing oven. Preferably, in such a forced drying configuration of the process in accordance with the invention, the duration of the drying may be between 30 seconds and 5 minutes.

After step (iii) of the process in accordance with the invention, an article whose support is coated with a sol-gel coating in accordance with the invention is obtained.

The thickness of the coating after implementation of the process in accordance with the invention can be comprised between 1 and 2000 μm, in particular comprised between 2 and 1000 μm, preferably comprised between 2 and 150 μm.

The thickness of the coating after implementation of the process in accordance with the invention with paramagnetic or diamagnetic conductive fillers can be comprised between 1 and 40 μm, in particular comprised between 2 and 30 μm, preferably comprised between 5 and 15 μm.

The thickness of the coating after carrying out the process in accordance with the invention with ferromagnetic conductive fillers can be comprised between 50 μm and 2 mm, in particular comprised between 70 μm and 1 mm, preferably comprised between 70 μm and 500 μm.

It should be noted that the thickness of the coating will depend on the D100 of the particles and, in particular, of the conductive fillers, and that generally the D100 cannot be greater than the thickness of the coating so that no element of the coating protrudes. However, in the case of oblong particles, whose width differs from their length, it is envisaged that the D100 may be greater than the thickness of the coating, the oblong particles being embedded in the coating without protruding from the coating layer.

The invention also relates to the use of conductive fillers to prepare a sol-gel coating to make a culinary article induction-compatible.

The conductive fillers make a culinary article induction-compatible, as a result of the dissipation of power by Joule effect at the level of the coating, resulting from the induced currents of the generator of the heating means.

The conductive fillers employed according to this use are those described above.

### DESCRIPTION OF THE FIGURES

FIG. 1 is a schematic cross-sectional representation of an example of an induction heating system. A container 1 containing water to be heated is placed on an induction cooktop. This cooktop comprises a glass-ceramic plate 4, induction coils 5 forming an electromagnet and an electrical power supply 6. In operation, the coils generate a magnetic field 3 which passes through the plate 4 and the bottom of the container 1. Depending on the material of the container 1, the latter becomes the seat of induced currents 2 causing it to heat up, and thus causes the water contained in the container 1 to heat up by thermal conduction.

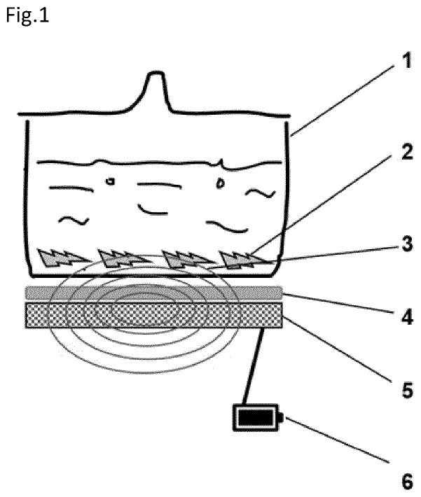

### EXAMPLES

### Laser Granulometry Method

In the present description, including the accompanying claims, granulometry and particle size are measured by laser particle size analysis, for example using a Malvern MS2000 laser particle size analyzer.

The measurement is carried out in a suitable medium, either via a wet process (for example in an aqueous or solvent medium) or via a dry process. The light source consists of a class 1 laser, with a red He—Ne light emission source and a blue diode. The optical model is the Mie model and the computational matrix is of Mie type.

The apparatus is regularly calibrated with a standard sample (several different powders of monodisperse latex) whose particle size curve is known. It is necessary to know the refractive index of each material used in order to make the necessary corrections during the laser diffraction analysis.

The alignment of the laser and the cleanliness of the analysis chambers are checked before the measurements.

A background noise measurement is first performed:
in the presence of water or solvent liquid for the wet process with a pump speed of 2000 rpm, an agitator speed of 800 rpm and a noise measurement over 10 s and in the absence of ultrasound; or
in the presence of air for the dry process with a noise measurement over 10 s.

It is then verified that the light intensity of the laser is at least equal to 80%, and that a decreasing exponential curve is obtained for the background noise. If this is not the case, the lenses of the cell must be cleaned.

Then a first measurement on the sample is performed with the following parameters:
wet process: pump speed of 2000 rpm, agitator speed of 800 rpm, no ultrasound, obscuration limit between 10 and 20%;
dry process: obscuration limit between 10 and 20%.

The sample is introduced to obtain an obscuration slightly higher than 10%. After stabilization of the obscuration, the measurement is carried out in the presence of ultrasound (to avoid agglomerates) with a duration of 10 s (acquisition time of 10 000 diffraction images analyzed). In the particle size distribution curve obtained, it must be taken into account that a part of the powder population could be agglomerated.

Without emptying the cell, the measurement is repeated at least twice to check the stability of the result and the evacuation of any bubbles.

All measurements presented in the description and the specified ranges correspond to the average values obtained with ultrasound.

### Products:

Sol-gel precursors:
methyltriethoxysilane (MTES);
tetraethoxysilane (TEOS);
trimethylborate;
Colloidal oxide: colloidal silica as a 40% aqueous solution of silica;
Solvents:
propan-2-ol;
terpinol;
butyl glycol;
Acid: hydrochloric acid;
Bases:
KOH;
NaOH;
NH₄OH;
Rheology agents:
urea modified acrylic copolymer;
ethyl cellulose with a viscosity of 18-22 mPa·s, measured for a 5% solution at 25° C. with an Ubbelohde viscometer;
acrylic polymer with a molar mass of 2500-5000 g·mol⁻¹;
Wetting agent: diol functionalized fluorinated polyether polymer;
Water: distilled water;
Conductive fillers:
silver powder no. 1 with D10 of 0.64 μm, D50 of 1.5 μm and D90 of 3.0 μm and D100 of 7.0 μm; and BET surface area >0.5 m²/g;
silver powder no. 2 with D10 of 0.97 μm, D50 of 3.03 μm, D90 of 7.62 μm and D100 of 25.43 μm; and BET surface area >0.5 m²/g;
ferromagnetic powder with D10 of 1-3 μm, D50 of 4-6 μm, D90 of 8.5-12 μm and D100 of 15 μm; and BET surface area >0.5 m²/g;
encapsulated aluminum with D10 of 2.0-6.0 μm, D50 of 7.0-11.0 μm, D90 of 12.0-17.0 μm and D100 of 15 μm; and BET surface area >0.5 m²/g;
Filler: alumina Al₂O₃;
Support: ceramic pottery;
Silicone oil: food grade reactive silicone oil.

### Compositions:

### Example 1: Sol-Gel Coating Composition in Accordance with the Invention Comprising a Silver Powder (Acid Route)

A sol-gel coating composition in accordance with the invention was made in the proportions described in the following Table 1.

TABLE 1

| Compounds | mass % |
|---|---|
| MTES | 15-20 |
| TEOS | 5-10 |
| Trimethylborate | 0.1-6 |
| Propan-2-ol | 1-2 |
| Terpineol | 5-7 |
| 40% colloidal silica | 5-10 |
| Hydrochloric acid | 0.2-0.4 |
| Wetting additive | 0.1-0.3 |
| Silver Powder no. 1 | 60-80 |
| Urea modified acrylic copolymer | 2.7 |
| TOTAL | 100 |

To make this composition, the silanes, trimethylborate with water, acid and colloidal silica were reacted to obtain the binder of the screen-printable sol-gel coating composition in accordance with the invention. The reaction was quite rapid (a few minutes to 1 hour) depending on the amounts to be produced. It is advisable to work under an extractor hood and to use a cooling system for the reactor walls, as the reaction is exothermic.

After stabilization and cooling of this mixture, the conductive fillers (silver powder) and/or pigments and/or reinforcing fillers were added progressively under dispersion.

Then the other components of the composition (solvents, additives and surfactants) were incorporated. After a few hours of rest, the paste was used to be screen printed.

The paste was stored in a refrigerator or at room temperature to ensure maximum rheological stability for several days to weeks.

A sol-gel coating composition in accordance with the invention was obtained.

### Example 2: Sol-Gel Coating Composition in Accordance with the Invention Comprising a Ferromagnetic Powder (Acid Route)

A sol-gel coating composition in accordance with the invention was made in the proportions described in the following Table 2.

TABLE 2

| Components | mass % |
|---|---|
| MTES | 20-40 |
| TEOS | 10-15 |
| Propan-2-ol | 1-2 |
| Terpineol | 5-7 |
| 40% colloidal silica | 5-10 |
| Hydrochloric acid | 0.2-0.4 |
| Wetting additive | 0.1-0.3 |
| Ferromagnetic powder | 50-70 |
| Ethyl cellulose | 5-10 |
| TOTAL | 100 |

This sol-gel coating composition in accordance with the invention was obtained according to the protocol described in Example 1.

### Example 3: Sol-Gel Coating Composition in Accordance with the Invention Comprising an Aluminum Powder (Acid Route)

A sol-gel coating composition in accordance with the invention was made in the proportions described in the following Table 3.

TABLE 3

| Components | mass % |
|---|---|
| MTES | 20-40 |
| TEOS | 10-15 |
| Trimethylborate | 0.1-6 |
| Propan-2-ol | 1-3 |
| Butyl glycol | 6-8 |
| 40% colloidal silica | 15-20 |
| Hydrochloric acid | 0.1-0.5 |
| Wetting additive | 0.1-1 |
| Reactive silicone oil | 0.1-0.5 |
| Al₂O₃ | 1-3 |
| Encapsulated aluminum | 50-70 |
| Urea modified acrylic copolymer | 1-5 |
| TOTAL | 100 |

This sol-gel coating composition in accordance with the invention was obtained according to the protocol described in Example 1.

### Example 4: Sol-Gel Coating Composition in Accordance with the Invention Comprising a Silver Powder (Basic Route)

A sol-gel coating composition in accordance with the invention was made in the proportions described in the following Table 4.

TABLE 4

| Components | mass % |
|---|---|
| MTES | 15-20 |
| TEOS | 5-10 |
| Trimethylborate | 0.1-6 |
| Propan-2-ol | 1-2 |
| Butyl glycol | 5-7 |
| KOH | 1-2 |
| NaOH | 1-2 |
| NH₄OH | 1-2 |
| Wetting additive | 0.1-0.3 |
| Silver powder no. 2 | 60-80 |
| Acrylic polymer | 2-4 |
| TOTAL | 100 |

To make this composition, the silanes, trimethylborate, soda, potash and ammonia were weighed in a glass flask. Then these components were stirred for 12 h in a 25° C. water bath. After 12 h, the solution was translucent yellowish, demineralized water was added dropwise very slowly because there was a risk of heating the solution and creating “flakes”. Then the solution was cooled to 25° C., before filtering it, first on 8-12 μm filter paper and under vacuum, then on 5-8 μm filter paper.

The conductive fillers (silver powder) were added gradually under dispersion. Then the other components of the composition (solvents, additives and surfactants) were incorporated. The paste was stored in a refrigerator or at room temperature in order to guarantee a maximum rheological stability of several days or weeks.

A sol-gel coating composition in accordance with the invention was obtained.

Supports Coated with a Coating

The sol-gel coating composition of Example 1 was applied to a ceramic pottery support (pan type container) in order to obtain a support coated with a sol-gel coating in accordance with the invention according to the following protocol:
first the container was cleaned, then heated to a temperature of 40 to 80° C.;
a decorative colored sol-gel coating composition was sprayed on the entire outer face of the container (outer skirt and bottom), followed by a drying time of a few seconds, at a temperature of 80 to 120° C. This composition did not comprise conductive fillers and was not in accordance with the invention. This decorative sol-gel coating composition was made according to the proportions described in the following Table 5;
then, the sol-gel coating composition of Example 1 was applied by brush in one or more layers until a thickness of 30 μm was obtained, followed by slow drying at a temperature of 80 to 120° C.;
the curing step was carried out at about 250° C. starting with a temperature rise to 250° C. in 5 minutes, followed by holding the temperature for 10 minutes at 250° C. and then cooling in 5 minutes.

TABLE 5

| Components | mass % |
|---|---|
| 40% colloidal silica | 20-30 |
| Water | 5-10 |
| Isopropanol | 1-5 |
| Butyl glycol | 0.2-4 |
| MTES | 25-45 |
| Trimethylborate | 0-5 |
| Formic acid | 0.34 |
| Black pigment | 14.14 |
| Alumina | 12.51 |
| Silicone oil | 0.1-2 |
| TOTAL | 100 |

A ceramic pottery pan coated on its outer bottom with the induction-compatible coating obtained by the application of the composition of Example 1 was obtained.

The resistivity of the sol-gel coating composition applied to the support was measured with a SOLEMS SQOHM-1 4-point multimeter. The calculated resistivity is 5·10⁻⁶.

### Tests

The induction heating performance of the ceramic pottery article with the bottom coated with the silver sol-gel composition of Example 1 was tested. The container was filled with 1 L of water and heated on an induction heating system. The results are shown in Table 6 below.

TABLE 6

| | | Temperature | Boiling time of |
|---|---|---|---|
| Induction cooktop | | reached in 13 | 1 L of water to |
| brand tested | Power | minutes | reach 100° C. |
| Brandt TI 126B | 600 W | 60° C. | 15 minutes |
| Miele KM 6114 | 450 W | 47° C. | 17 minutes |

1. A sol-gel coating composition comprising conductive fillers, for making a culinary article induction-compatible.

2. The composition according to claim 1, wherein the conductive fillers are ferromagnetic, diamagnetic or paramagnetic.

3. The composition according to claim 1, wherein the conductive fillers are selected from silver, copper, aluminum, iron, nickel, cobalt, stainless steel, carbon black and mixtures thereof.

4. The composition according to claim 1, wherein it comprises from 40 to 90% conductive fillers, percentages expressed by mass based on the total mass of the sol-gel coating composition.

5. The composition according to claim 1, wherein it comprises at least one sol-gel precursor selected from metal or metalloid alkoxylate type precursors and metal or metalloid polyalkoxylate type sol-gel precursors.

6. The composition according to claim 5, wherein the sol-gel precursor is selected from tetraethoxysilane (TEOS), methyltriethoxysilane (MTES), methyltrimethoxysilane (MTMS) and mixtures thereof.

7. A sol-gel coating comprising at least one layer of the sol-gel coating composition according to claim 1.

8. A culinary article comprising a support coated with the sol-gel coating according to claim 7.

9. The culinary article according to claim 8, wherein said support is of inorganic material or of organic material.

10. The culinary article according to claim 8, wherein an outer face of the support of the article is coated with the sol-gel coating.

11. A process for manufacturing an induction-compatible culinary article comprising the following successive steps:
(i) provide a support;
(ii) apply to the support the sol-gel coating composition according to claim 1;
(iii) apply a heat treatment at a temperature of 200 to 500° C.;
(iv) obtain an article whose support is coated with a sol-gel coating.

12. Use of conductive fillers to prepare a sol-gel coating in order to make a culinary article induction-compatible.

13. The composition according to claim 4, wherein it comprises from 50 to 85% conductive fillers, percentages expressed by mass based on the total mass of the sol-gel coating composition.

14. The culinary article according to claim 9, wherein inorganic material is glass or ceramic and organic material is plastic.

15. The composition according to claim 1, wherein the conductive fillers are ferromagnetic, diamagnetic or paramagnetic, it comprises from 40 to 90% conductive fillers, percentages expressed by mass based on the total mass of the sol-gel coating composition and it comprises at least one sol-gel precursor selected from metal or metalloid alkoxylate type precursors and metal or metalloid polyalkoxylate type sol-gel precursors.
